(19) United States
(12) Patent Application Publication
(10) Pub. No.: US 2023/0384423 A1
(43) Pub. Date: Nov. 30, 2023

(54) METHOD FOR ANALYZING SHAPE OF OBJECT BY USE OF LIDAR THROUGH ADDITIONAL ANALYSIS OF WHOLE LAYER DATA AND DEVICE FOR TRACKING OBJECT ACCORDING TO THE SAME

(71) Applicants: HYUNDAI MOTOR COMPANY, Seoul (KR); KIA CORPORATION, Seoul (KR)

(72) Inventor: Mi Rim Noh, Jeonju-si (KR)

(73) Assignees: Hyundai Motor Company, Seoul (KR); KIA CORPORATION, Seoul (KR)

(21) Appl. No.: 17/984,876

(22) Filed: Nov. 10, 2022

(30) Foreign Application Priority Data
May 31, 2022 (KR) 10-2022-0066765

(51) Int. Cl. G01S 7/48; G01S 17/66; G01S 17/931

(52) U.S. Cl. CPC G01S 7/4802; G01S 17/66; G01S 17/931

(57) ABSTRACT

The present disclosure relates to a method of analyzing a shape of an object by use of LiDAR and a device for tracking an object according to the same. A method for analyzing a shape of an object by use of LiDAR, according to an embodiment of the present disclosure, comprises obtaining first to M^{th} (M is an integer of 2 or greater) layers of LiDAR points spaced apart in a vertical direction with respect to an object by the LiDAR sensor, obtaining LiDAR points of a whole layer by projecting whole LiDAR points for the object or LiDAR points of the first to M^{th} layers onto the whole layer, and determining shape flags for the first to M^{th} layers and the whole layer, respectively, each by use of at least a part of corresponding LiDAR points of each layer according to a plurality of predetermined shape types, and determining a shape flag of the object.

### CROSS-REFERENCE TO RELATED APPLICATION

The present application claims priority to Korean Patent Application No. 10-2022-0066765, filed on May 31, 2022 in the Korean Intellectual Property Office, the entire contents of which is incorporated herein for all purposes by this reference.

### TECHNICAL FIELD

The present disclosure relates to a method of analyzing a shape of an object by use of LiDAR and a device for tracking an object according to the same.

### BACKGROUND

Information about a target vehicle may be acquired using a light detection and ranging (LiDAR) sensor(s), and an autonomous driving function of a vehicle (hereinafter referred to as a “host vehicle”) equipped with the LiDAR sensor may be assisted by using the acquired information. However, when information about a target vehicle, which is acquired using a LiDAR sensor, is incorrect, the reliability of the host vehicle for autonomous driving may be deteriorated. Therefore, research for solving this problem is underway.

In particular, when multiple-layered point data are obtained for an object through a LiDAR sensor and the heading of the object is determined from a layer selected through analyzing LiDAR points of each layer, if the selection of the layer is not appropriate, the reliability may also be greatly deteriorated.

The information included in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method for analyzing a shape of an object and a device for tracking an object by use of a LiDAR sensor, which is capable of analyzing a shape and the heading of a moving object.

Technical aspects of the present disclosure are not limited to the foregoing aspects, and other technical aspects will be apparent to a person having ordinary skills in the art from the description.

A method for analyzing a shape of an object by use of a LiDAR sensor, according to an embodiment of the present disclosure, comprises obtaining first to M^{th} (M is an integer of 2 or greater) layers of LiDAR points spaced apart in a vertical direction with respect to an object by the LiDAR sensor, obtaining LiDAR points of a whole layer by projecting whole LiDAR points for the object or LiDAR points of the first to M^{th} layers onto the whole layer, and determining shape flags for the first to M^{th} layers and the whole layer, respectively, each by use of at least a part of the corresponding LiDAR points according to a plurality of predetermined shape types, and determining a shape flag of the object.

In at least one embodiment, the determining of the shape flag of the object comprises steps of (a) determining the shape flags for the respective first to M^{th} layers, (b) determining the shape flag of the object firstly by use of the shape flags of the first to M^{th} layers; and (c) determining the shape flag for the whole layer and accordingly changing or maintaining the firstly determined shape flag of the object.

In at least one embodiment, the step (c) is performed according to a predetermined reliability condition for the firstly determined shape flag of the object.

In at least one embodiment, the predetermined reliability condition includes one of: condition I representing whether a L-shape flag is temporarily determined as the shape flag of the object according to a priority order rule due to a L-shape flag being assigned to at least one among the first to M^{th} layers and I-shape flag layers are more than L-shape flag layers or a maximum score among L-shape flag scores is below a predetermined first score and a maximum score of I-shape flag scores is equal to or over a predetermined second score, condition II representing whether when the firstly determined shape flag of the object is a L-shape, a heading flag score for the object is equal to or below a predetermined score, condition III representing whether, with respect to the firstly determined shape flag of the object, a difference of distances from a host vehicle between a shape box and a cluster box for the object in its heading layer is equal to or over a predetermined value, and condition IV representing whether only one of the first to M^{th} layers is determined as a L-shape flag and thus the firstly determined shape flag of the object becomes the L-shape.

In at least one embodiment, the step (c) comprises changing the shape of the object according to the shape flag of the whole layer when the condition I is true and a L-shape or sL-shape flag is determined as the shape flag of the whole layer.

In at least one embodiment, heading information on the object is determined according to the firstly determined shape flag of the object.

In at least one embodiment, the step (c) comprises changing the shape of the object according to the shape flag of the whole layer when any one of the conditions II to IV is true and the L-shape or an sL-shape flag is determined as the shape flag of the whole layer.

In at least one embodiment, heading information on the object is determined according to the shape flag of the whole layer.

In at least one embodiment, the step (c) comprises changing the shape of the object to be ‘unknown’ when the condition III is true and neither the L-shape nor an sL-shape flag is determined as the shape flag of the whole layer.

In at least one embodiment, a heading flag determined for heading information on the object is deleted.

In at least one embodiment, the firstly determined shape flag of the object is maintained when any one of the conditions II to IV is true and the shape flag of the whole layer is neither the L-shape nor an sL-shape flag.

In at least one embodiment, a heading flag determined for heading information on the object is deleted.

In at least one embodiment, the firstly determining of the shape flag of the object comprises calculating each of confidence scores for each of the shape flags of the first to M^{th} layers by use of the at least part of the corresponding LiDAR points, and determining the shape flag of the object by use of the shape flags and the confidence scores determined for the first to M^{th} layers.

A device for tracking an object by use of a LiDAR sensor according to an embodiment of the present disclosure comprises the LiDAR sensor configured to obtain a point cloud including LiDAR points for a target object, a clustering unit configured to group the LiDAR points of the point cloud, and a shape analysis unit configured to analyze a shape of the target object from the grouped LiDAR points of the point cloud, wherein the shape analysis unit comprises a layer shape determination unit configured to determine shape flags for first to M^{th} layers and a whole layer, respectively, by use of at least a part of corresponding LiDAR points of each of the first to Mth layers and the whole layer according to a plurality of predetermined shape types, the first to M^{th} (M is an integer of 2 or greater) layers spaced apart in a vertical direction with respect to the target object and LiDAR points of the whole layer obtained by projecting whole LiDAR points for the targe object or LiDAR points of the first to M^{th} layers onto the whole layer in the vertical direction, and a target shape determination unit configured to determine a shape flag of the object by use of the shape flags of the first to M^{th} layers and the whole layer.

In at least one embodiment, the determination of the shape flag of the object is performed by steps of (a) determining shape flags for the respective first to M^{th} layers, (b) determining the shape flag of the object firstly by use of the shape flags of the first to M^{th} layers, and (c) determining the shape flag for the whole layer and accordingly changing or maintaining the firstly determined shape flag of the target object.

In at least one embodiment, the step (c) is performed according to a predetermined reliability condition for the firstly determined shape flag of the object.

In at least one embodiment, the predetermined reliability condition includes one of: condition I representing whether a L-shape flag is temporarily determined as the shape flag of the object according to a priority order rule due to a L-shape flag being assigned to at least one among the first to M^{th} layers and I-shape flag layers are more than L-shape flag layers or a maximum score among L-shape flag scores is below a predetermined first score and a maximum score of I-shape flag scores is equal to or over a predetermined second score, condition II representing whether when the firstly determined shape flag of the object is a L-shape, a heading flag score for the object is equal to or below a predetermined score, condition III representing whether, with respect to the firstly determined shape flag of the object, a difference of distances from a host vehicle between a shape box and a cluster box for the object in its heading layer is equal to or over a predetermined value, and condition IV representing whether only one of the first to M^{th} layers is determined as a L-shape flag and thus the firstly determined shape flag of the object becomes a L-shape.

A vehicle according to an embodiment of the present disclosure comprises the device for tracking an object as described above.

According to an embodiment of the present disclosure, the shape and heading of a target object can be obtained more precisely by use of a LiDAR sensor.

And also, the performance and reliability of an autonomous vehicle can be enhanced.

The methods and devices of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a schematic block diagram of an object-tracking device using a LiDAR sensor according to an embodiment.

FIG. 2 is a flowchart of a method of analyzing the shape of an object using a LiDAR sensor according to an embodiment.

FIG. 3 is a block diagram of an embodiment of the shape analysis unit shown in FIG. 1.

FIG. 4 is a flowchart of an embodiment of step 210 shown in FIG. 2.

FIG. 5 is a diagram exemplarily showing LiDAR points included in the m^{th} layer.

FIG. 6 is a flowchart of an embodiment of step 316 shown in FIG. 4.

FIG. 7 is a flowchart of an embodiment of step 318 shown in FIG. 4.

FIGS. 8A and 8B are exemplary diagrams for helping understanding step 318A shown in FIG. 7.

FIG. 9 is a flowchart of an embodiment of step 320 shown in FIG. 4.

FIG. 10 is a diagram for helping understanding the embodiment shown in FIG. 9.

FIG. 11 is a flowchart of another embodiment of step 320 shown in FIG. 4.

FIG. 12 is a diagram for helping understanding the embodiment shown in FIG. 11.

FIG. 13 is a flowchart of an embodiment of step 322 shown in FIG. 4.

FIG. 14 is a diagram for helping understanding step 602 shown in FIG. 13.

FIGS. 15(a) and 15(b) are diagrams for helping understanding step 604 shown in FIG. 13.

FIG. 16 is a diagram for helping understanding step 606 shown in FIG. 13.

FIG. 17 is a flowchart of an embodiment of step 220 shown in FIG. 2.

FIG. 18 is a flowchart of an example of step 650 shown in FIG. 17.

FIG. 19 shows various types of target vehicles on the basis of a host vehicle.

FIGS. 20 to 23 represent actual test results of an embodiment of the present disclosure showing an example of the determination of a shape flag.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

In case where identical elements are included in various embodiments, they will be given the same reference numerals, and redundant description thereof will be omitted. In the following description, the terms “module” and “unit” for referring to elements are assigned and used interchangeably in consideration of convenience of explanation, and thus, the terms per se do not necessarily have different meanings or functions.

Furthermore, in describing the exemplary embodiments, when it is determined that a detailed description of related publicly known technology may obscure the gist of the exemplary embodiments, the detailed description thereof will be omitted. The accompanying drawings are used to help easily explain various technical features and it should be understood that the exemplary embodiments presented herein are not limited by the accompanying drawings. Accordingly, the present disclosure should be construed to extend to any alterations, equivalents and substitutes in addition to those which are particularly set out in the accompanying drawings.

Although terms including ordinal numbers, such as “first”, “second”, etc., may be used herein to describe various elements, the elements are not limited by these terms. These terms are generally only used to distinguish one element from another.

When an element is referred to as being “coupled” or “connected” to another element, the element may be directly coupled or connected to the other element. However, it should be understood that another element may be present therebetween. In contrast, when an element is referred to as being “directly coupled” or “directly connected” to another element, it should be understood that there are no other elements therebetween.

A singular expression includes the plural form unless the context clearly dictates otherwise.

In the exemplary embodiment, it should be understood that a term such as “include” or “have” is intended to designate that the features, numbers, steps, operations, elements, parts, or combinations thereof described in the specification are present, and does not preclude the possibility of addition or presence of one or more other features, numbers, steps, operations, elements, parts, or combinations thereof.

Unless otherwise defined, all terms including technical and scientific ones used herein have the same meanings as those commonly understood by one of ordinary skill in the art to which this disclosure belongs. It will be further understood that terms, such as those defined in commonly used dictionaries, should be interpreted as having meanings consistent with their meanings in the context of the relevant art and the present disclosure, and are not to be interpreted in an idealized or overly formal sense unless expressly so defined herein.

Furthermore, the term “unit” or “control unit” included in the names of a hybrid control unit (HCU), a motor control unit (MCU), etc. is merely a widely used term for naming a controller configured for controlling a specific vehicle function, and does not mean a generic functional unit. For example, each controller may include a communication device that communicates with another controller or a sensor to control a function assigned thereto, a memory that stores an operating system, a logic command, input/output information, etc., and one or more processors that perform determination, calculation, decision, etc. necessary for controlling a function assigned thereto.

Hereinafter, a method 200 of analyzing a shape of an object and a device 100 for tracking an object using a LiDAR sensor according to embodiments will be described with reference to the accompanying drawings. The method 200 of analyzing the shape of an object and the device 100 for tracking an object using a LiDAR sensor will be described using the Cartesian coordinate system (x-axis, y-axis, z-axis) for convenience of description, but may also be described using other coordinate systems. In the Cartesian coordinate system, the x-axis, the y-axis, and the z-axis are perpendicular to each other, but the embodiments are not limited thereto. That is, the x-axis, the y-axis, and the z-axis may intersect each other obliquely.

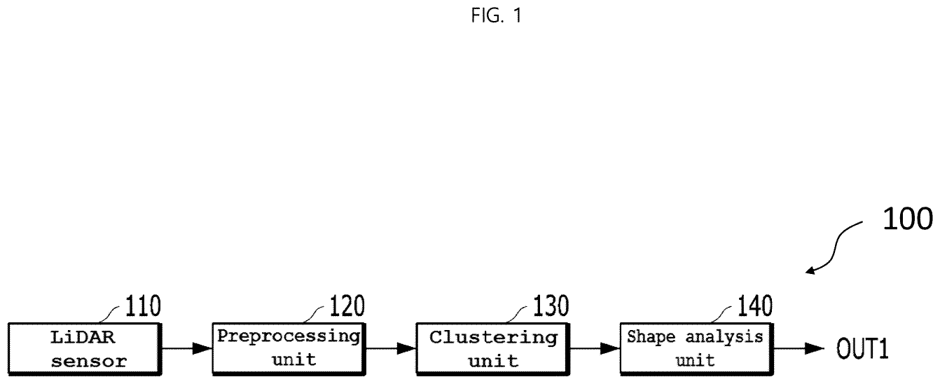

FIG. 1 is a schematic block diagram of an object-tracking device 100 using a LiDAR sensor according to an embodiment.

The object-tracking device 100 shown in FIG. 1 may include a LiDAR sensor(s) 110, a preprocessing unit 120, a clustering unit 130, and a shape analysis unit 140. In this embodiment, the LiDAR sensor 110 may be suitable to obtain a plurality of layers of LiDAR data for the object, each layer responsible for LiDAR point data of the object at its corresponding position on a vertical axis.

According to an exemplary embodiment of the present disclosure, the object-tracking device 100 may include a processor (e.g., computer, microprocessor, CPU, ASIC, circuitry, logic circuits, etc.) and an associated non-transitory memory storing software instructions which, when executed by the preprocessing unit 120, the clustering unit 130, and the shape analysis unit 140. Herein, the memory and the processor may be implemented as separate semiconductor circuits. Alternatively, the memory and the processor may be implemented as a single integrated semiconductor circuit. The processor may embody one or more processor(s).

The LiDAR sensor 110 may acquire a point cloud related to a target object, and may output the acquired point cloud to the preprocessing unit 120 as LiDAR data. The preprocessing unit 120 may preprocess the LiDAR data. To this end, the preprocessing unit 120 may perform calibration to match the coordinates between the LiDAR sensor 110 and a vehicle equipped with the LiDAR sensor 110 (hereinafter referred to as a “host vehicle”). That is, the preprocessing unit 120 may convert the LiDAR data into data suitable for the reference coordinate system in consideration of the positional angle at which the LiDAR sensor 110 is mounted to the host vehicle. In addition, the preprocessing unit 120 may perform filtering to remove points having low intensity or reflectance using intensity or confidence information of the LiDAR data. In addition, the preprocessing unit 120 may remove data reflected from the host vehicle. That is, since there is a region that is shielded by the body of the host vehicle depending on the mounting position and the field of view of the LiDAR sensor 110, the preprocessing unit 120 may remove data reflected from the body of the host vehicle using the reference coordinate system. The preprocessing unit 120 according to an exemplary embodiment of the present disclosure may be a hardware device implemented by various electronic circuits (e.g., computer, microprocessor, CPU, ASIC, circuitry, logic circuits, etc.). The preprocessing unit 120 may be implemented by a non-transitory memory storing, e.g., a program(s), software instructions reproducing algorithms, etc., which, when executed, performs various functions described hereinafter, and a processor configured to execute the program(s), software instructions reproducing algorithms, etc. Herein, the memory and the processor may be implemented as separate semiconductor circuits. Alternatively, the memory and the processor may be implemented as a single integrated semiconductor circuit. The processor may embody one or more processor(s).

The clustering unit 130 may group the point cloud, which is the LiDAR data composed of a plurality of points related to the object acquired using the LiDAR sensor 110, into meaningful units according to a predetermined criterion. That is, the clustering unit 130 may cluster the point cloud using the result of the preprocessing by the preprocessing unit 120, and may output the clustered LiDAR points to the shape analysis unit 140. The clustering unit 130 according to an exemplary embodiment of the present disclosure may be a hardware device implemented by various electronic circuits (e.g., computer, microprocessor, CPU, ASIC, circuitry, logic circuits, etc.). The clustering unit 130 may be implemented by a non-transitory memory storing, e.g., a program(s), software instructions reproducing algorithms, etc., which, when executed, performs various functions described hereinafter, and a processor configured to execute the program(s), software instructions reproducing algorithms, etc. Herein, the memory and the processor may be implemented as separate semiconductor circuits. Alternatively, the memory and the processor may be implemented as a single integrated semiconductor circuit. The processor may embody one or more processor(s).

The shape analysis unit 140 may analyze the shape of a target object using the clustered LiDAR points of the point cloud, and may output the result of the analysis through an output terminal OUT1. The shape analysis unit 140 according to an exemplary embodiment of the present disclosure may be a hardware device implemented by various electronic circuits (e.g., computer, microprocessor, CPU, ASIC, circuitry, logic circuits, etc.). The shape analysis unit 140 may be implemented by a non-transitory memory storing, e.g., a program(s), software instructions reproducing algorithms, etc., which, when executed, performs various functions described hereinafter, and a processor configured to execute the program(s), software instructions reproducing algorithms, etc. Herein, the memory and the processor may be implemented as separate semiconductor circuits. Alternatively, the memory and the processor may be implemented as a single integrated semiconductor circuit. The processor may embody one or more processor(s).

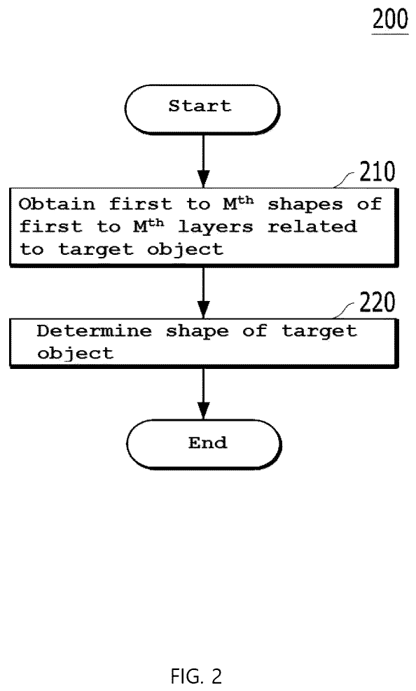

FIG. 2 is a flowchart of a method 200 of analyzing the shape of an object using a LiDAR sensor according to an embodiment.

The shape analysis unit 140 shown in FIG. 1 may perform the shape analysis method 200 shown in FIG. 2, but the embodiment is not limited thereto. That is, according to another embodiment, the shape analysis method 200 shown in FIG. 2 may be performed by an object-tracking device configured differently from the object-tracking device 100 shown in FIG. 1. That is, the method 200 shown in FIG. 2 is not limited to any specific type of operation performed by the LiDAR sensor 110, the presence or absence of the preprocessing unit 110, any specific type of preprocessing performed by the preprocessing unit 110, or any specific type of clustering performed by the clustering unit 130 in the device shown in FIG. 1.

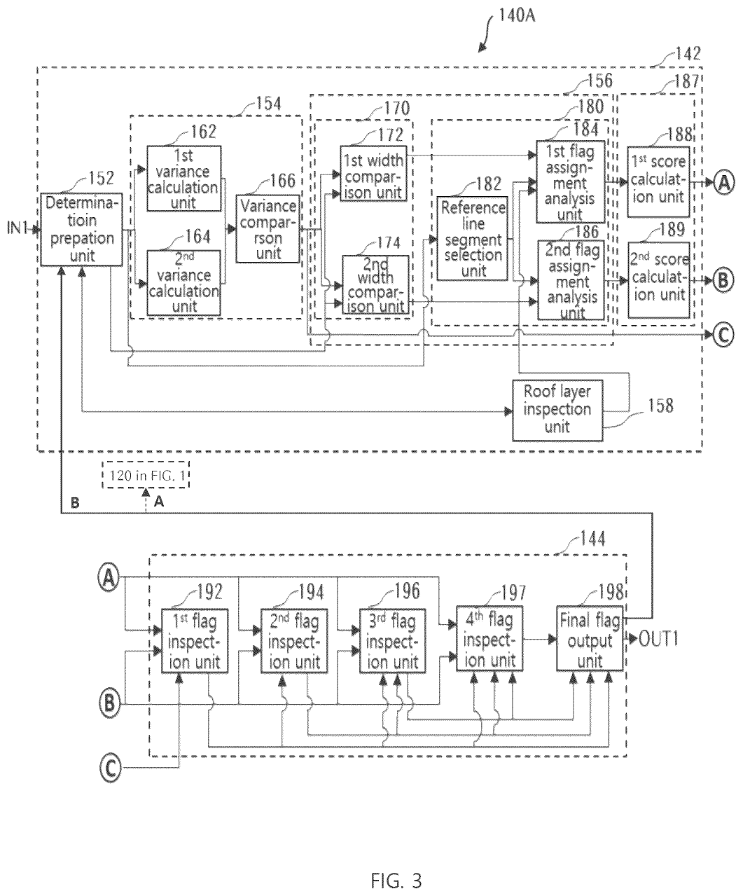

FIG. 3 is a block diagram of an embodiment 140A of the shape analysis unit 140 shown in FIG. 1.

Hereinafter, for better understanding, the object shape analysis method 200 according to the embodiment will be described as being performed by the shape analysis unit 140A shown in FIG. 3, but the embodiment is not limited thereto. That is, according to another embodiment, the object shape analysis method 200 according to the embodiment may also be performed by a shape analysis unit configured differently from the shape analysis unit 140A shown in FIG. 3.

The shape analysis unit 140A shown in FIG. 3 may include a layer shape determination unit 142 and a target shape determination unit 144.

The layer shape determination unit 142 may receive the clustered LiDAR points from the clustering unit 130 through an input terminal IN1, may determine the first to Mt h shapes of first to M^{th} layers related to a target object using the LiDAR points, and may output the determined shapes of the first to M^{th} layers to the target shape determination unit 144 (step 210). Here, “M” is a positive integer of 2 or greater.

After step 210, the target shape determination unit 144 may finally determine the shape of the target object by analyzing the 1^{st} to M^{th} shapes according to a predetermined priority, and may output the determined shape of the target object through the output terminal OUT1 (step 220).

Hereinafter, embodiments of the object shape analysis method 200 shown in FIG. 2, the layer shape determination unit 142 shown in FIG. 3, and the target shape determination unit 144 shown in FIG. 3 will be described with reference to the accompanying drawings.

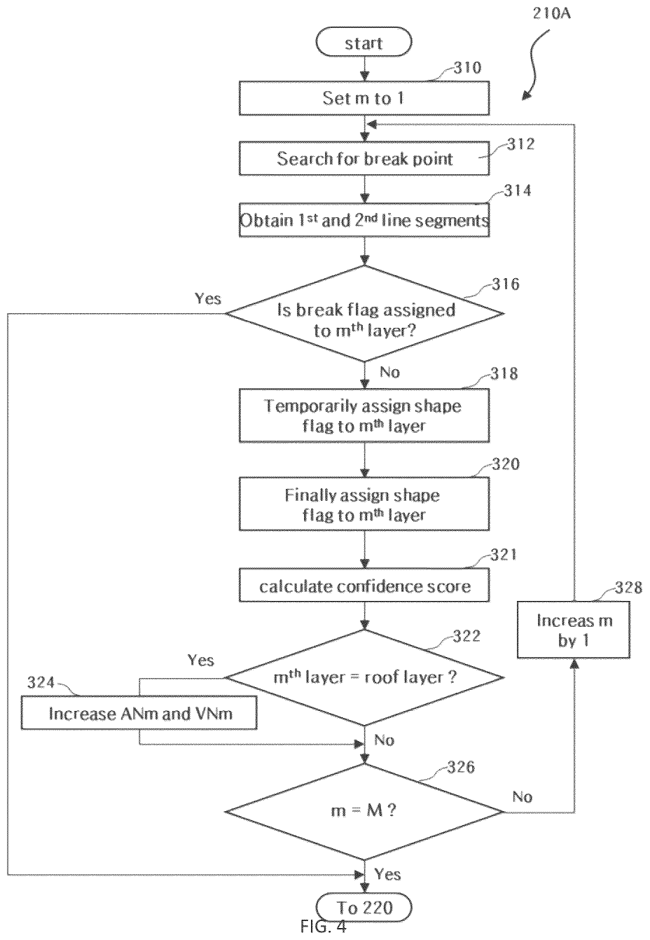

FIG. 4 is a flowchart of an embodiment 210A of step 210 shown in FIG. 2.

The layer shape determination unit 142 shown in FIG. 3 may perform the method 210A shown in FIG. 4. To this end, the layer shape determination unit 142 may include a determination preparation unit 152 and a flag assignment unit 156. In addition, the layer shape determination unit 142 may further include a moving object analysis unit 154. In addition, the layer shape determination unit 142 may further include a roof layer inspection unit 158.

The shape of each of the M layers, i.e. the first to M^{th} layers, related to one target object may be determined as follows.

First, “m” is set to 1 (step 310). Here, 1≤m≤M.

After step 310, among the LiDAR points included in the m^{th} layer, the break point that is located farthest from the line segment (or baseline) connecting the first end point and the second end point is searched for (step 312).

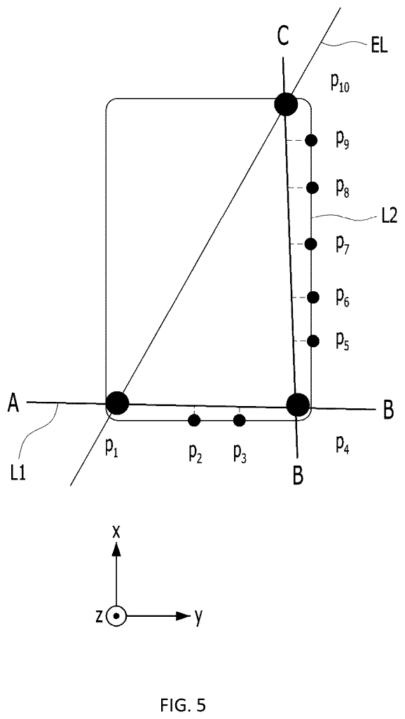

FIG. 5 is a diagram exemplarily showing the LiDAR points included in the m^{th} layer.

For better understanding, step 210A shown in FIG. 4 will be described with reference to FIG. 5, but is not limited thereto.

The LiDAR points related to one target object may be divided into M layers, i.e. the first to M^{th} layers, in a vertical direction (e.g. the z-axis direction).

After step 310, among the LiDAR points included in the m^{th} layer (e.g. p1 to p10 shown in FIG. 5), the break point B (p4) that is located farthest from the line segment EL connecting the first end point A (p1) and the second end point C (p10) is searched for (step 312).

Thereafter, a first line segment L1 connecting the first end point p1 and the break point p4 and a second line segment L2 connecting the second end point p10 and the break point p4 are generated (step 314).

Steps 310 to 314 described above may be performed by the determination preparation unit 152 shown in FIG. 3.

After step 314, the moving object analysis unit 154 may analyze the distribution pattern of the first and second LiDAR points in the m^{th} layer, and may determine whether to assign a break flag to the m^{th} layer as a shape flag using the result of the analysis (step 316).

Here, the first LiDAR points may be LiDAR points (e.g. p2 and p3) located near the first line segment L1, among the LiDAR points (e.g. p1 to p10 shown in FIG. 5). The second LiDAR points may be LiDAR points (e.g. p5 to p9 shown in FIG. 5) located near the second line segment L2, among the LiDAR points (e.g. p1 to p10 shown in FIG. 5).

The break flag may be a flag indicating that the possibility that the target object displayed through the LiDAR points included in the m^{th} layer is a moving object is low. That is, when the degree to which the LiDAR points are dispersed in the m^{th} layer is large, there is a possibility that the target object is a static object rather than a moving object. Therefore, it is possible to check whether the target object is a moving object or a static object using the variance of the LiDAR points.

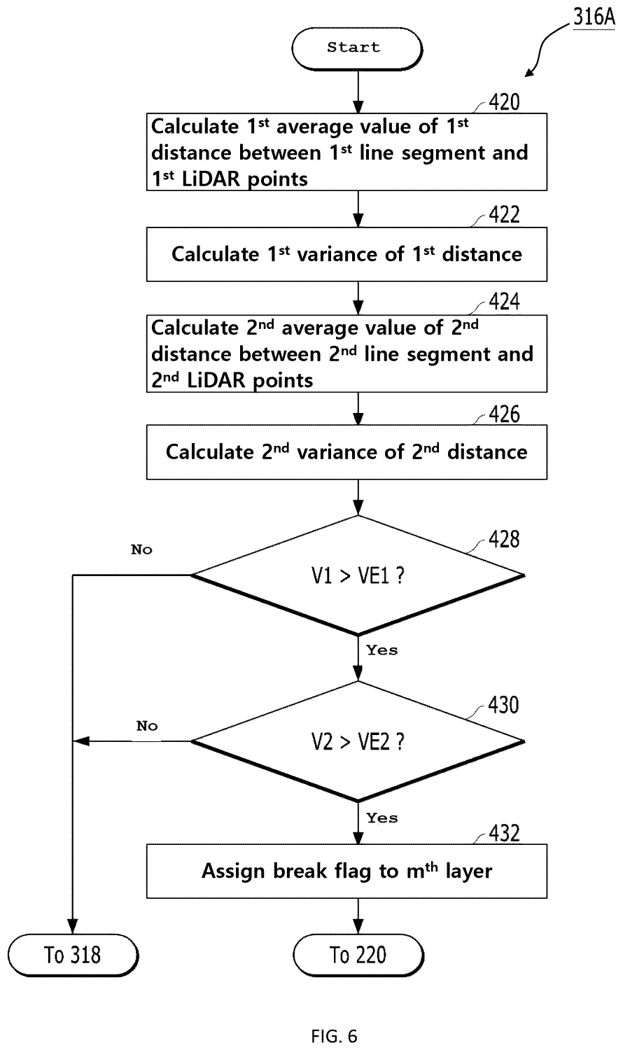

FIG. 6 is a flowchart of an embodiment 316A of step 316 shown in FIG. 4.

The moving object analysis unit 154 may perform step 316A shown in FIG. 6. To this end, the moving object analysis unit 154 may include, for example, a first variance calculation unit 162, a second variance calculation unit 164, and a variance comparison unit 166.

For example, referring to FIGS. 3 and 6, after step 314, the first variance calculation unit 162 calculates a first average value A1 of the first distances between the first line segment L1 and the first LiDAR points, as expressed using Equation 1 below (step 420).

$$A 1 = \frac{1}{n} {\sum }_{i = 1}^{n} x i \qquad [ Equation 1 ]$$

Here, “n” represents the total number of first LiDAR points included in the m^{th} layer, and “xi” represents the first distances. Referring to FIG. 5, “xi” corresponds to the spacing distances between the respective first LiDAR points p2 and p3 and the first line segment L1 in the x-axis direction.

After step 420, the first variance calculation unit 162 calculates a first variance V1 of the first distances xi using the first average value A1 of the first distances xi, as expressed using Equation 2 below, and outputs the calculated first variance V1 to the variance comparison unit 166 (step 422).

$$V 1 = \frac{1}{n} {\sum }_{i = 1}^{n} {( xi - A 1 )}^{2} \qquad [ Equation 2 ]$$

After step 422, the second variance calculation unit 164 calculates a second average value A2 of the second distances yi between the second line segment L2 and the second LiDAR points, as expressed using Equation 3 below (step 424).

$$A 2 = \frac{1}{q} {\sum }_{i = 1}^{q} yi \qquad [ Equation 3 ]$$

Here, “q” represents the total number of second LiDAR points included in the m^{th} layer, and “yi” represents the second distances. Referring to FIG. 5, “yi” corresponds to the spacing distances between the respective second LiDAR points p5 to p9 and the second line segment L2 in the y-axis direction.

After step 424, the second variance calculation unit 164 calculates a second variance V2 of the second distances yi using the second average value A2 of the second distances yi, as expressed using Equation 4 below, and outputs the calculated second variance V2 to the variance comparison unit 166 (step 426).

$$V 2 = \frac{1}{q} {\sum }_{i = 1}^{q} {( yi - A 2 )}^{2} \qquad [ Equation 4 ]$$

After step 426, the variance comparison unit 166 determines whether the first variance V1 is greater than a first variance threshold value VE1 (step 428). If the first variance V1 is greater than the first variance threshold value VE1, the variance comparison unit 166 determines whether the second variance V2 is greater than a second variance threshold value VE2 (step 430). Upon determining that the second variance V2 is greater than the second variance threshold value VE2, the variance comparison unit 166 may assign the break flag to the m^{th} layer, and the process may go to step 220 (step 432). The first and second variance threshold values VE1 and VE2 may be the same as or different from each other. Further, each of the first and second variance threshold values VE1 and VE2 may be set in advance for each layer and stored, or may be set in advance to a constant value regardless of the layers.

However, when the first variance V1 is not greater than the first variance threshold value VE1 or when the second variance V2 is not greater than the second variance threshold value VE2, the possibility that the m^{th} layer is a moving object rather than a static object is higher, and thus the process goes to step 318. For example, the static object may be an object that does not move, such as a traffic light, a tree, a traffic sign, or a guardrail, and the moving object may be an object that is moving, such as a vehicle.

As described above, the variance comparison unit 166 compares the first variance V1 and the second variance V2 with the first variance threshold value VE1 and the second variance threshold value VE2, respectively, and assigns a break flag to the m^{th} layer in response to the result of the comparison.

Alternatively, step 316 may be omitted from the object shape analysis method 200 using a LiDAR sensor according to the embodiment.

Meanwhile, when the break flag is not assigned to the m^{th} layer, the flag assignment unit 156 may assign a shape flag to the m^{th} layer using at least one of the first line segment, the second line segment, the first LiDAR points, or the second LiDAR points (steps 318 and 320).

To this end, as shown in FIG. 3, the flag assignment unit 156 may include a temporary flag assignment unit 170 and a final flag assignment unit 180.

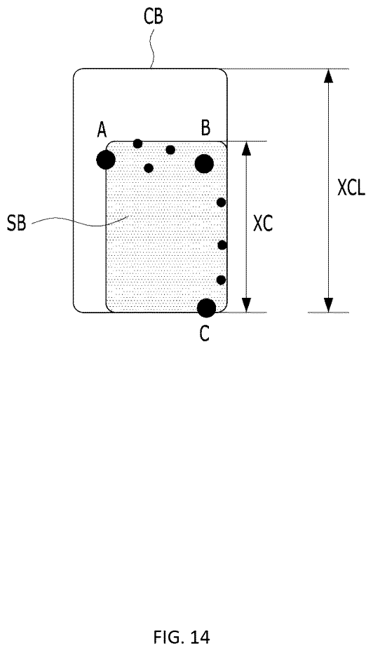

The temporary flag assignment unit 170 temporarily assigns an L-shaped flag or an I-shaped flag to the m^{th} layer as a shape flag in consideration of the size of the shape box of the m^{th} layer including the first and second line segments L1 and L2 in response to the result of the comparison by the variance comparison unit 166. The shape box will be described later in detail with reference to FIG. 14. That is, upon recognizing that the break flag has not been assigned to the m^{th} layer because the first variance V1 is not greater than the first variance threshold value VE1 and/or because the second variance V2 is not greater than the second variance threshold value VE2 as a result of the comparison by the variance comparison unit 166, the temporary flag assignment unit 170 may temporarily assign an L-shaped flag or an I-shaped flag to the m^{th} layer as a shape flag in consideration of the size of the shape box of the m^{th} layer including the first and second line segments (step 318).

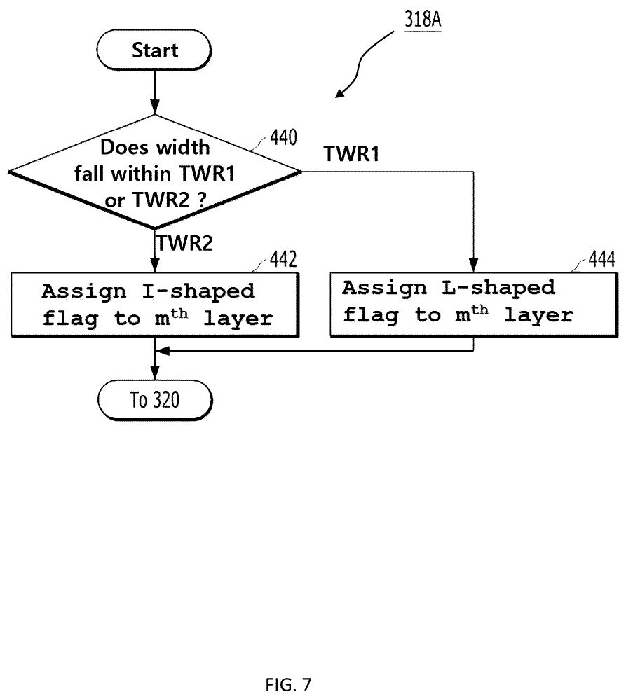

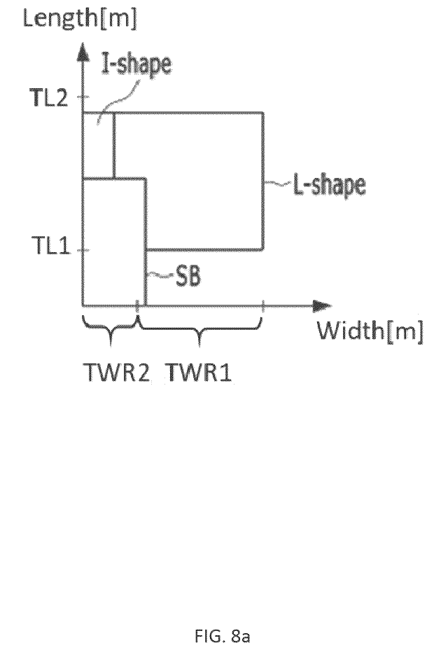

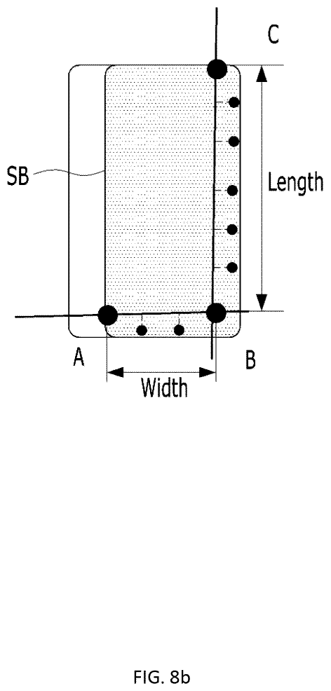

FIG. 7 is a flowchart of an embodiment 318A of step 318 shown in FIG. 4. FIGS. 8A and 8B are exemplary diagrams for helping understanding step 318A shown in FIG. 7.

For example, the temporary flag assignment unit 170 may temporarily assign an L-shaped flag or an I-shaped flag to the m^{th} layer using at least one of the length or the width of the shape box (e.g. SB shown in FIG. 8B) of the m^{th} layer.

That is, when it is recognized that the break flag has not been assigned to the m^{th} layer, whether the width of the shape box of the m^{th} layer falls within a first threshold width range TWR1 or a second threshold width range TWR2 may be determined (step 440).

If the width of the shape box of the m^{th} layer falls within the first threshold width range TWR1, the I-shaped flag is temporarily assigned to the m^{th} layer (step 442). However, if the width of the shape box falls within the second threshold width range, the L-shaped flag is temporarily assigned to the m^{th} layer (step 444).

When the first threshold width range TWR1 has a range of the first minimum value MIN1 to the first maximum value MAX1 and the second threshold width range TWR2 has a range of the second minimum value MIN2 to the second maximum value MAX2, the second minimum value MIN2 may be greater than or equal to the first maximum value MAX1. In this way, the shape flag may be assigned to the m^{th} layer using the width of the shape box SB, but the embodiment is not limited thereto. That is, according to another embodiment, the shape flag may be temporarily assigned to the m^{th} layer using at least one of the width or the length of the shape box SB.

The device 100 according to the embodiment may track an object having a length of a predetermined value TL2 or less. When the length of the shape box SB shown in FIG. 8B falls within the range of TL1 to TL2, if the width of the shape box SB falls within the first threshold width range TWR1, the I-shaped flag may be temporarily assigned to the m^{th} layer, and if the width of the shape box SB falls within the second threshold width range TWR2, the L-shaped flag may be temporarily assigned to the m^{th} layer.

In order to perform the method shown in FIG. 7, as shown in FIG. 3, the temporary flag assignment unit 170 may include first and second width comparison units 172 and 174.

In conclusion, the temporary flag assignment unit 170 may temporarily assign the L-shaped flag or the I-shaped flag to the m^{th} layer using at least one of the length or the width of the shape box SB (step 318A).

The first width comparison unit 172 may compare the width of the shape box SB with the first threshold width range TWR1, and may temporarily assign the L-shaped flag to the m^{th} layer in response to the result of the comparison. If the length of the shape box SB is equal to or smaller than a predetermined length, the sL-shape flag may be temporally assigned. To this end, after determining the L-shape flag for the shape of the corresponding layer due to the comparison result that the width of the shape box SB is within the first threshold width range TWR1, the first width comparison unit 172 may compare the length of the shape box SB with the predetermined length to determine whether to assign temporally the L-shape or the sL-shape flag to the layer. The second width comparison unit 174, on the other hand, may compare the width of the shape box SB with the second threshold width range TWR2, and may temporarily assign the I-shaped flag to the m^{th} layer in response to the result of the comparison.

After step 318, the final flag assignment unit 180 may determine whether to finally assign the L-shaped flag, the sL-shaped flag or the I-shaped flag, which has been temporarily assigned to the m^{th} layer, using at least one of the first line segment L1, the second line segment L2, the first LiDAR points, or the second LiDAR points (step 320).

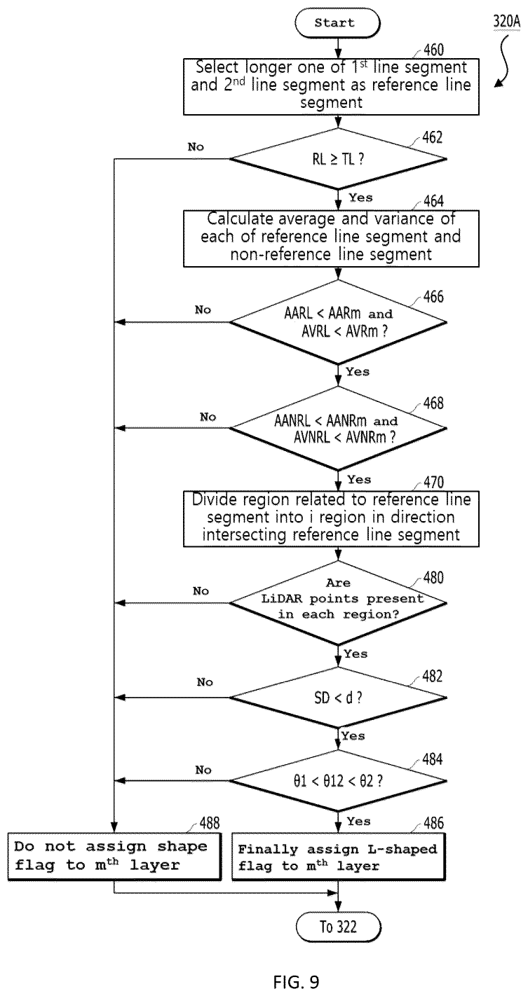

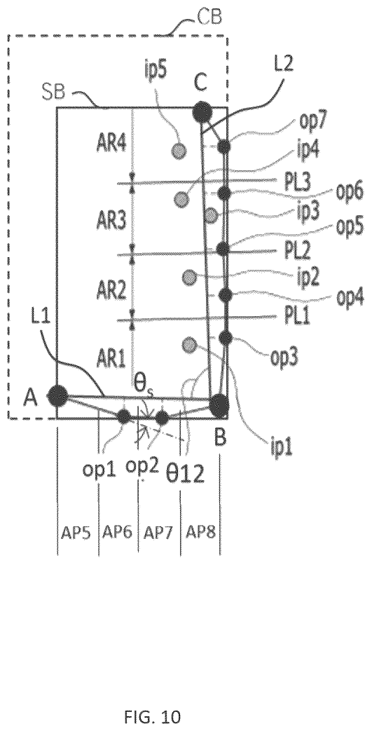

FIG. 9 is a flowchart of an embodiment 320A of step 320 shown in FIG. 4, and FIG. 10 is a diagram for helping understanding the embodiment 320A shown in FIG. 9. In FIG. 10, it is assumed that the first and second line segments L1 and L2 correspond to the first and second line segments L1 and L2 obtained in step 314, respectively.

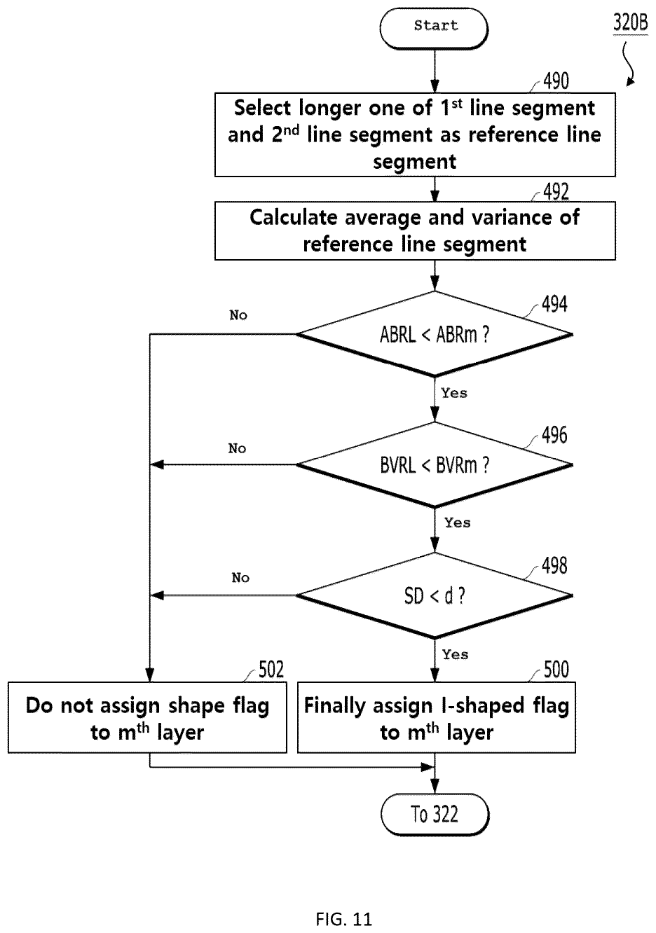

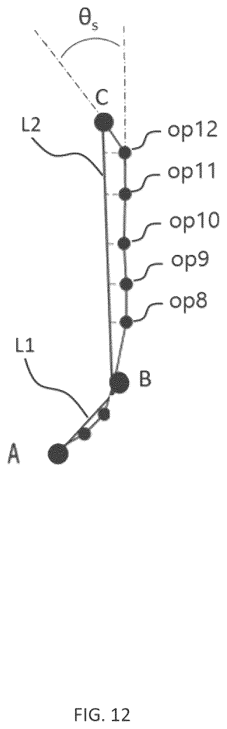

FIG. 11 is a flowchart of another embodiment 320B of step 320 shown in FIG. 4, and FIG. 12 is a diagram for helping understanding the embodiment 320B shown in FIG. 11.

FIGS. 10 and 12 represent an example of a case where the corresponding object is located at the left upper side region (i.e., the second quadrant) from the host vehicle, and though the processes of FIGS. 9 and 11 are detailed below therewith, they can be applied to objects located at other side region. Also, though the L-shape flag is assumed in FIGS. 9 and 11, the processes can be applied to the sL-shape flag too, and thus the details for the sL-shape flag are omitted.

When the L-shaped flag was temporarily assigned to the m^{th} layer in step 318, the shape flag may be finally assigned to the m^{th} layer through the method 320A shown in FIG. 9 (step 320A). However, when the I-shaped flag was temporarily assigned to the m^{th} layer in step 318, the shape flag may be finally assigned to the m^{th} layer through the method 320B shown in FIG. 11 (step 320B).

In order to perform the embodiments 320A and 320B shown in FIGS. 9 and 11, the final flag assignment unit 180 may include, for example, a reference line segment selection unit 182, a first flag assignment analysis unit 184, and a second flag assignment analysis unit 186, as shown in FIG. 3.

Upon recognizing that the L-shaped flag has been assigned to the m^{th} layer based on the result of the comparison by the first width comparison unit 172, the first flag assignment analysis unit 184 may perform steps 462 to 488 shown in FIG. 9. However, step 462 shown in FIG. 9 may be performed by the reference line segment selection unit 182, rather than the first flag assignment analysis unit 184.

After step 318, the reference line segment selection unit 182 selects the longer line segment from among the first line segment L1 and the second line segment L2, provided from the determination preparation unit 152, as a reference line segment, and selects the shorter line segment from among the first line segment L1 and the second line segment L2 as a non-reference line segment (step 460). For example, referring to FIG. 10, since the second line segment L2 is longer than the first line segment L1, the first line segment L1 may be selected as a non-reference line segment, and the second line segment L2 may be selected as a reference line segment.

After step 460, whether the length RL of the reference line segment (e.g. L2) is greater than or equal to a threshold length TL is checked (step 462). Here, the threshold length may be set differently for each of the M layers, or may be set identically.

If the length RL of the reference line segment is not greater than or equal to the threshold length TL, the shape flag is not assigned to the m^{th} layer (step 488). However, when the length RL of the reference line segment is greater than or equal to the threshold length TL, the average and the variance of each of the reference line segment and the non-reference line segment are calculated (step 464).

Here, the average of the reference line segment means an average of the distances between the reference line segment and the LiDAR points located near the reference line segment, and the variance of the reference line segment means a variance of the distances between the reference line segment and the LiDAR points located near the reference line segment. The average of the non-reference line segment means an average of the distances between the non-reference line segment and the LiDAR points located near the non-reference line segment, and the variance of the non-reference line segment means a variance of the distances between the non-reference line segment and the LiDAR points located near the non-reference line segment.

After step 464, whether the average AARL and the variance AVRL of the reference line segment are less than a reference threshold average AARm and a reference threshold variance AVRm, respectively, is checked (step 466). Here, each of the reference threshold average AARm and the reference threshold variance AVRm may be set in advance for each set of coordinates of the m^{th} layer and stored, or may be set in advance to a constant value regardless of the coordinates of the m^{th} layer and stored.

If the average AARL of the reference line segment is not less than the reference threshold average AARm, or if the variance AVRL of the reference line segment is not less than the reference threshold variance AVRm, the shape flag is not assigned to the m^{th} layer (step 488).

However, if the average AARL of the reference line segment is less than the reference threshold average AARm and the variance AVRL of the reference line segment is less than the reference threshold variance AVRm, whether the average AANRL and variance AVNRL of the non-reference line segment are less than a non-reference threshold average AANRm and a non-reference threshold variance AVNRm, respectively, is checked (step 468). Here, each of the non-reference threshold average AANRm and the non-reference threshold variance AVNRm may be set in advance for each set of coordinates of the m^{th} layer and stored, or may be set in advance to a constant value regardless of the coordinates of the m^{th} layer and stored.

If the average AANRL of the non-reference line segment is not less than the non-reference threshold average AANRm, or if the variance AVNRL of the non-reference line segment is not less than the non-reference threshold variance AVNRm, the shape flag is not assigned to the m^{th} layer (step 488).

However, when the average AANRL of the non-reference line segment is less than the non-reference threshold average AANRm and the variance AVNRL of the non-reference line segment is less than the non-reference threshold variance AVNRm, the region related to the reference line segment is divided into i regions in the direction intersecting the reference line segment (step 470). Here, “i” is a positive integer of 1 or greater, preferably 3 or greater. For example, “i” may be 4. For example, referring to FIG. 10, it can be seen that the region related to the reference line segment L2 is divided into four (i=4) regions AR1 to AR4 in the direction intersecting the reference line segment L2. In order to divide the region, three (i−1=3) straight lines may be arranged so as to be oriented in the direction intersecting the reference line segment L2.

After step 470, whether a LiDAR point is present in each of the i regions resulting from the division is checked (step 480). In other words, whether a LiDAR point are present in each of the four divided regions AR1 to AR4 is checked (step 480). If no LiDAR point is present in even one of the four regions resulting from the division, the shape flag is not assigned to the m^{th} layer (step 488).

However, when the LiDAR point is present in each of the regions resulting from the division, whether the spacing distance SD between neighboring outer LiDAR points located in the regions resulting from the division is less than a threshold spacing distance d is checked (step 482). Here, the threshold spacing distance d may be set in advance. In FIG. 10, a line segment can be defined by connecting two neighboring outer LiDAR points with a straight line. For example, a line segment connecting the outer points op1 and op2, a line segment connecting the outer points op3 and op4, a line segment connecting the outer points op4 and op5, a line segment connecting the outer points op5 and op6, and a line segment connecting the outer points op6 and op7 may be defined, and in step 482, whether the length SDs of the segments is less than the threshold spacing distance d is determined. If the length SD of a segment is not less than the threshold spacing distance d, a shape flag is not assigned to the m^{th} layer (step 488).

To determine the outer points, for example, ‘Convex hull’ algorithm may be used. According to the ‘Convex hull’ algorithm, if a point in-between two neighboring points is located at the nearer side to the host vehicle with respect to the line segment connecting the two neighboring points, then the point is extracted as an outer point of the object, and vice versa.

If the length SDs of the segments are less than the threshold spacing distance d, whether the angle θ12 between the first line segment L 1 and the second line segment L2 is greater than a first angle θ1 and less than a second angle θ2 is determined (step 484). Here, the first angle θ1 and the second angle θ2 may be set in advance for each layer, or may be set in advance to a constant value regardless of the layers. If the angle θ12 between the first line segment L1 and the second line segment L2 is less than the first angle θ1 or greater than the second angle θ2, the shape flag is not assigned to the m^{th} layer (step 488).

However, if the angle θ12 between the first line segment L1 and the second line segment L2 is greater than the first angle θ1 and less than the second angle θ2, the L-shaped flag is finally assigned to the m^{th} layer (step 486).

Upon recognizing that the I-shaped flag has been assigned to the m^{th} layer based on the result of the comparison by the second width comparison unit 174, the second flag assignment analysis unit 186 may perform steps 492 to 502 shown in FIG. 11.

First, referring to FIG. 11, the longer line segment among the first line segment L1 and the second line segment L2 is selected as the reference line segment (step 490). Since step 490 is the same as step 460, a description thereof will be omitted.

After step 490, whether the average ABRL and the variance BVRL of the reference line segment (L2 shown in FIG. 12) are less than a reference threshold average ABRm and a reference threshold variance BVRm, respectively, is determined (steps 494 and 496). Here, the reference threshold average ABRm and the reference threshold variance BVRm may be the same as the reference threshold average AARm and the reference threshold variance AVRm shown in FIG. 9, respectively, and may be set in advance for each of the M layers and stored, or may be set in advance to a constant value regardless of the layers and stored.

If the average ABRL is not less than the reference threshold average ABRm or if the variance BVRL is not less than the reference threshold variance BVRm, the shape flag is not assigned to the m^{th} layer (step 502). However, if the average ABRL is less than the reference threshold average ABRm and the variance BVRL is less than the reference threshold variance BVRm, whether the spacing distance SDs between the outer points located in j regions resulting from the division in the direction intersecting the reference line segment are less than the threshold spacing distance d is determined (step 498). Here, “j” is a positive integer of 1 or greater. “j” may be the same as or different from “i”. Since step 498 is the same as step 482, a duplicate description thereof will be omitted.

If the spacing distance SD is not less than the threshold spacing distance d, the shape flag is not assigned to the m^{th} layer (step 502). However, if the spacing distance SD is less than the threshold spacing distance d, the I-shaped flag is finally assigned to the m^{th} layer (step 500).

Meanwhile, referring again to FIG. 4, step 210A may further include step 322, which is performed after step 320. That is, the layer shape determination unit 142 shown in FIG. 3 may further include a roof layer inspection unit 158, which performs step 322. In some embodiments, step 322 and the roof layer inspection unit 158 may be omitted.

After the flag is finally assigned to the m^{th} layer, a confidence score (hereinafter, referred to merely as ‘score’) is calculated according the type of the flag (step 321).

To calculate the score, the layer shape determination unit 142 may further comprise a score calculation unit 187 comprising a first score calculation unit 188 and a second score calculation unit 189.

At first, in case of L-shape or sL-shape flag, with reference to FIG. 3, the first calculation unit 188 calculates a first score, and in case of I-shape flag, the calculation unit 189 calculates a second score.

The calculation of the first score is detailed with reference to FIG. 10 and the calculation of the second score with reference to FIG. 12.

In the present embodiment, the first score is calculated by applying weights for five parameters, but not limited thereto.

For the convenience sake, the above mentioned parameters are referred to as L-parameters.

A first L-parameter LPS1 relates to the distance variance of the outer points to the first line segment L1 and the second line segment L2, and is obtained by calculating the variances to the first line segment L1 and the second line segment L2, respectively, and summing a first-line-segment score and a second-line-segment score accordingly obtained with reference to TABLE 1 below.

TABLE 1

| | First-line- | Second-line- |
|---|---|---|
| | segment score | segment score |
| Variance¹ < AV₁ | 50 | 50 |
| AV₁ ≤ variance < AV₂ | 20 | 20 |
| AV₂ ≤ variance | 0 | 0 |

^{†1}variance to the first line segment L1 or the second line segment L2.

With reference to TABLE 1, if the calculated variance is below a first predetermined variance value AV1, then 50 is assigned to the score, if the variance equal to or over the AV1 and below a second predetermined variance value AV2, then 20 assigned, and if the variance equal to or over the AV2, then 0 assigned.

For example, assuming that the distance variance of the outer points op1 and op2 to the first line segment L1 is below the first predetermined variance value AV1, and the distance variance of the outer points op3 to op7 to the second line segment L2 is equal to or over the first predetermined variance value AV1 and below the second predetermined variance value AV2, 50 is assigned to the first-line-segment score and 20 to the second-line-segment score, and thus the first L-parameter LPS1 is determined to have a score of 70.

Next, the second L-parameter LPS2 relates to the locations of the outer points with respect to the first and second line segments, respectively, and is determined according to the proportions of the points located at the nearer side to the host vehicle with respect to the first and second line segments, respectively.

In this embodiment, if the outer points associated to the first line segment L1 are all located at the host vehicle side with respect to the first line segment L1 and the outer points associated to the second line segment L2 are all located at the host vehicle side with respect to the second line segment L2, then 100 is assigned to the score, and otherwise 0.

For example, because the outer points op1 and op2 are located at the host vehicle side with respect to the first line segment L1, and the outer points op3 to op7 are located at the host vehicle side with respect to the second line segment L2, the score of the second L-parameter becomes 100.

Next, the third L-parameter relates to the average angle of minimum relative angles between neighboring segments.

With respect to FIG. 10, the minimum relative angle between two neighboring segments is defined as ‘180—the smaller angle between the segments,’ i.e. θs in FIG. 10 for the segment of points A and op1 and the segment of points op1 and op2, the smaller angle between two segments determined to be the smaller one among the two angles formed by two neighboring segments, and the third L-parameter LPS3 is obtained by assigning and summing scores for the respective first and second line segments, each score determined according to TABLE 2 by the average angle of the associated segments, the segments associated to the first line segment L1 defined as the segments of A-op1, op1-op2, and op2-B, and the segments associated to the second line segment L2 as the ones of B-op3, op3-op4, op4-op5, op5-op6, op6-op7, and op7-C.

TABLE 2

| | First Line | Second Line |
|---|---|---|
| | Segment | Segment |
| | (L1) Score | (L2) Score |
| average angle < Ang₁ | 50 | 50 |
| Ang₁ ≤ average angle < Ang₂ | 25 | 25 |
| Ang₂ ≤ average angle | 0 | 0 |

With reference to TABLE 2, for the score for each line segment, if the average angle is below a first predetermined angle Ang1, then 50 is assigned, if the average angle equal to or over the first predetermined angle Ang1 and below a second predetermined angle Ang2, then 25 assigned, and if the average angle over the second predetermined angle Ang2, then 0 assigned.

For example, assuming that the average angle between segments for the first line segment L1 is below the first predetermined angle Ang1 and the average angle between segments for the second line segment L2 is equal to or over the first predetermined angle Ang1 and below the second predetermined angle Ang2, 50 is assigned to the first line segment score and 20 to the second line segment score, and thus the third L-parameter LPS3 is determined to have a score of 70.

Next, the fourth L-parameter LPS4 relates to a straight line reliability, in more detail to whether the outer points are evenly distributed. This parameter is determined according to the presence of an outer point in each inner side division area other than either outer side among the division areas which are formed by dividing each of the line segments with 3 or more perpendicular lines.

In the present embodiment, for at least one of the first line segment L1 and the second line segment L2, if there exists at least one outer point in each inner side division area among the equally divided areas, then 100 is assigned to the score, and otherwise 0 is assigned.

For example, with reference to FIG. 10, because there exists an outer point in each of the inner side division areas AP6 and AP7 associated to the first line segment L1 and there, too, exists an outer point in each of the inner side division areas AP2 and AP3 associated to the second line segment L2, the score of the fourth L-parameter LPS4 becomes 100.

Next, the fifth L-parameter LPS5 relates to a proportion between the cluster box CB and the shape box SB.

If the size ratio of the shape box SB to the cluster box CB is equal to or over a predetermined value, then 100 is assigned to the score, and otherwise 0 assigned.

Preferably, the size ratio is calculated by use of the longer side lengths of the two boxes.

The first score is calculated by the following Equation 5 with the above mentioned L-parameters.

1^{st} score=LPS1×w1+LPS2×w2+LPS3×w3+LPS4×w4+LPS5×w5 [Equation 5]

In Equation 5, w1, w2, w3, w4 and w5 are weights for respective L-parameters.

Optimal values may be determined for the above weights through tests. Preferably, the fifth weight w5 is greatest, the next greatest one is the first weight w1 or the fourth weight w4, and the second weight w2 or the third weight w3 is the next.

In the present embodiment, all of the five L-parameters are used to calculate the first score, but not limited thereto. For example, only one of the five parameters may be used, and also any two or more may be used together. Preferably, as the parameters for the calculation of the first score, the fifth L-parameter LPS5 is necessarily included, and more preferably, the first and the fourth L-parameters LPS1 and LPS4 are included too, without limited thereto.

The calculation of the second score is detailed with reference to FIG. 12.

In the present embodiment, the second score is calculated by applying weights to two parameters, respectively, but not limited thereto.

For the convenience sake, the parameters are referred to as I-parameters.

At first, a first I-parameter IPS1 relates to the distance variance of the outer points to the second line segment L2 (or the reference line segment, the same below), and its score is determined with the variance to the second line segment L2 with reference to TABLE 3 below.

TABLE 3

| | IPS1 score |
|---|---|
| variance < AV₃ | 100 |
| AV₃ ≤ variance < AV₄ | 50 |
| AV₄ ≤ variance | 0 |

With reference to TABLE 3, if the calculated variance is below a third predetermined variance value AV3, then 100 is assigned to the score, if the variance equal to or over the third predetermined variance value AV3 and below a fourth predetermined variance value AV4, then 50 assigned, and if the variance equal to or over the fourth predetermined variance value AV4, then 0 assigned.

For example, in FIG. 12, assuming that the distance variance of the outer points op8 to op12 to the second line segment L2 is below the third predetermined variance value AV3, the score for the first I-parameter IPS1 becomes 100.

Next, a second I-parameter IPS2 relates to the average of minimum relative angles between segments, likewise the third L-parameter LPS3. The second I-parameter IPS2, however, is calculated only for the second line segment L2.

With reference to 12, the second I-parameter IPS2 is determined through TABLE 4 below according to the average angle of the minimum relative angles between segments.

TABLE 4

| | IPS2 Score |
|---|---|
| average angle < Ang₃ | 100 |
| Ang₃ ≤ average angle < Ang₄ | 50 |
| Ang₄ ≤ average angle | 0 |

With reference to TABLE 4, for the score of the second I-parameter IPS2, if the average angle is below a third predetermined angle Ang3, then 100 is assigned, if the average angle equal to or over the third predetermined angle Ang3 and below a fourth predetermined angle Ang4, then 50 assigned, and if the average angle equal to or over the fourth predetermined angle Ang4, then 0 assigned.

For example, assuming that the average angle between segments associated to the second line segment L2, the second I-parameter IPS2 is determined to have the score of 100.

The second score is calculated by Equation 6 below by use of the above described I-parameters.

[Equation 6]

[symbol]

In Equation 5, g1 and g2 are weights for respective I-parameters.

Optimal values of the weights may be determined through test, too. Preferably, the first weight g1 is greater than the second weight w2, but not limited thereto.

After step 321, the roof layer inspection unit 158 may check whether the m^{th} layer is a layer related to the roof of the target object (hereinafter referred to as a “roof layer”), and may output the result of the checking to the first flag assignment analysis unit 184 and the determination preparation unit 152 (step 322). If the m^{th} layer is the roof layer of the target object, the non-reference threshold average AANRm and the non-reference threshold variance AVNRm, which are used for the m+1th layer in step 320, i.e. step 468 shown in FIG. 9, may be increased (step 324). In this way, when the non-reference threshold average AANRm and the non-reference threshold variance AVNRm are increased, conditions to be considered in order to assign the L-shaped flag to the m+1^{th} layer may be relaxed. The purpose of this is that, when the target object is a vehicle, the structural characteristic of the target vehicle in which the front bumper is rounder than the rear bumper is reflected in the determination as to whether to assign the L-shaped flag to the m+1^{th} layer.

Step 324 may be performed by the first flag assignment analysis unit 184, the roof layer inspection unit 158, or the determination preparation unit 152.

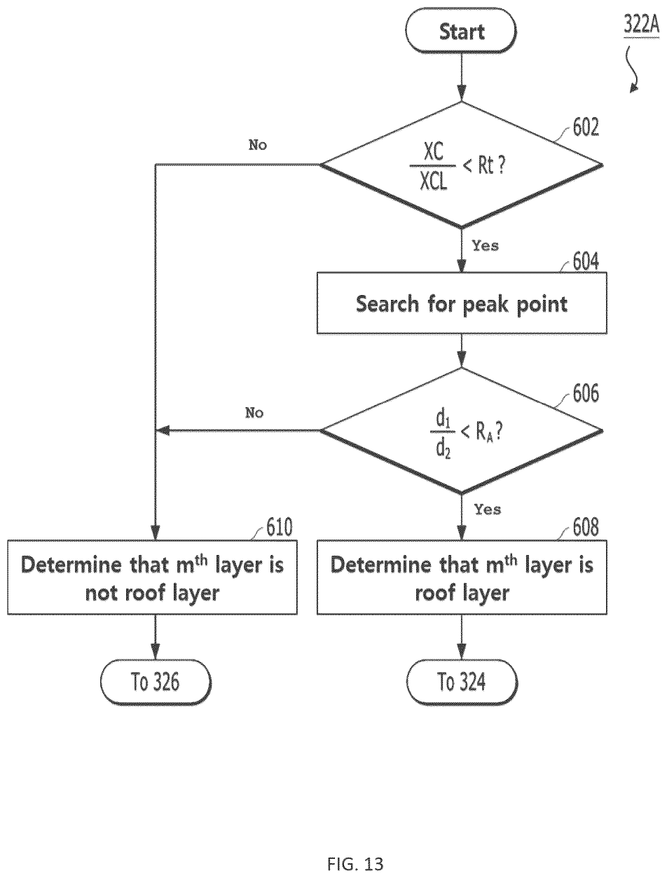

FIG. 13 is a flowchart of an embodiment 322A of step 322 shown in FIG. 4, and FIGS. 14 to 16 are diagrams for helping understanding step 322A shown in FIG. 13.

In FIG. 14, the clustering box CB may be a box including the LiDAR points related to the first to M^{th} layers, and the shape box SB may be a box including the LiDAR points related to the m^{th} layer.

According to the embodiment, the roof layer inspection unit 158 may perform steps 602 to 610 shown in FIG. 13.

First, referring to FIG. 14, whether the first ratio R1 of the length XC of the shape box SB of the m^{th} layer to the length XCL of the clustering box CB related to the target object is less than a first threshold ratio Rt is determined as in Equation 7 below (step 602).

$$\frac{X C}{X C L} ≺ R t \qquad [ Equation 7 ]$$

Here, “XC/XCL” represents the first ratio R1. The first threshold ratio Rt may be set in advance for each of the M layers, or may be set in advance to a constant value regardless of the M layers.

If the first ratio R1 is less than the first threshold ratio Rt, a peak point is searched for according to each shape flag finally assigned to the m^{th} layer (step 604). For example, the roof layer inspection unit 158 may determine a LiDAR point located farthest from the shorter one of the first line segment L1 and the second line segment L2 to be a peak point, or may determine the break point to be a peak point in response to the result of the comparison between the first ratio R1 and the first threshold ratio Rt and the result of the final assignment of the shape flag by the final flag assignment unit 184.

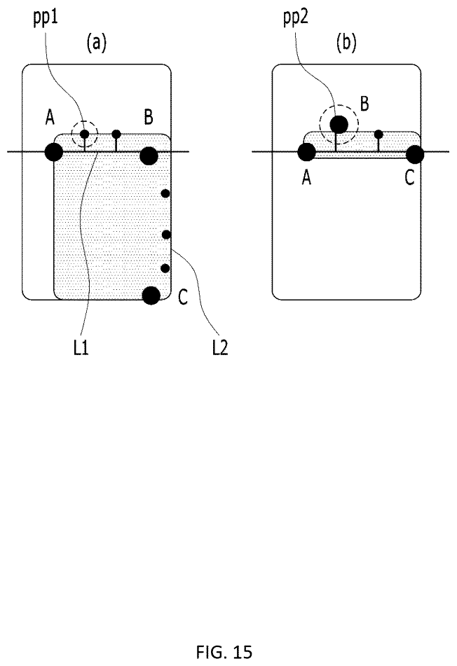

In detail, in the case in which the L-shaped flag is finally assigned to the m^{th} layer, referring to FIG. 15(a), the LiDAR point pp1 located farthest from the shorter one (L1 in FIG. 15(a)) of the first line segment L1 and the second line segment L2 may be determined to be a peak point. Alternatively, in the case in which the I-shaped flag is finally assigned to the m^{th} layer, as shown in FIG. 15(b), the break point (point located at region B) pp2 may be determined to be a peak point.

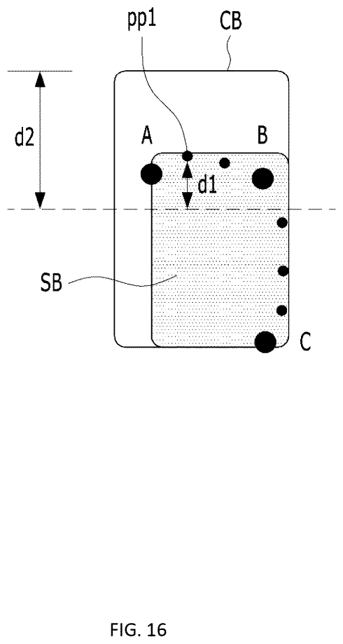

After step 604, whether the second ratio of the length from the peak point to the middle of the clustering box to half the length of the clustering box is less than a second threshold ratio may be checked (step 606). For example, when the L-shaped flag is finally assigned to the m^{th} layer and the peak point is determined to be pp1 shown in FIG. 15(a), as shown in FIG. 16, whether the second ratio R2 of the length d1 from the peak point pp1 to the middle of the clustering box CB to half d2 the length of the clustering box CB is less than the second threshold ratio RA may be checked as in Equation 8 below.

$$\frac{d 1}{d 2} ≺ {R}_{A} \qquad [ Equation 8 ]$$

Here, “d1/d2” represents the second ratio R2. The second threshold ratio RA may be set in advance for each of the M layers, or may be set in advance to a constant value regardless of the M layers.

If the second ratio R2 is less than the second threshold ratio RA, it is determined that the m^{th} layer is the roof layer of the target object (step 608). However, if the first ratio R1 is not less than the first threshold ratio Rt or if the second ratio R2 is not less than the second threshold ratio RA, it is determined that the m^{th} layer is not the roof layer of the target object (step 610).

Referring again to FIG. 4, after it is determined that the m^{th} layer is not the roof layer of the target object, or after step 324, whether m is M is checked (step 326). If m is not M, m is increased by 1, and then the process goes to step 312 (step 328). Accordingly, steps 312 to 324 are performed on the m+1th layer. That is, the shape flag may be assigned to the m+1th layer in the same method as the method of assigning the shape flag to the m^{th} layer. For example, steps 326 and 328 may be performed by the determination preparation unit 152, but the embodiment is not limited thereto.

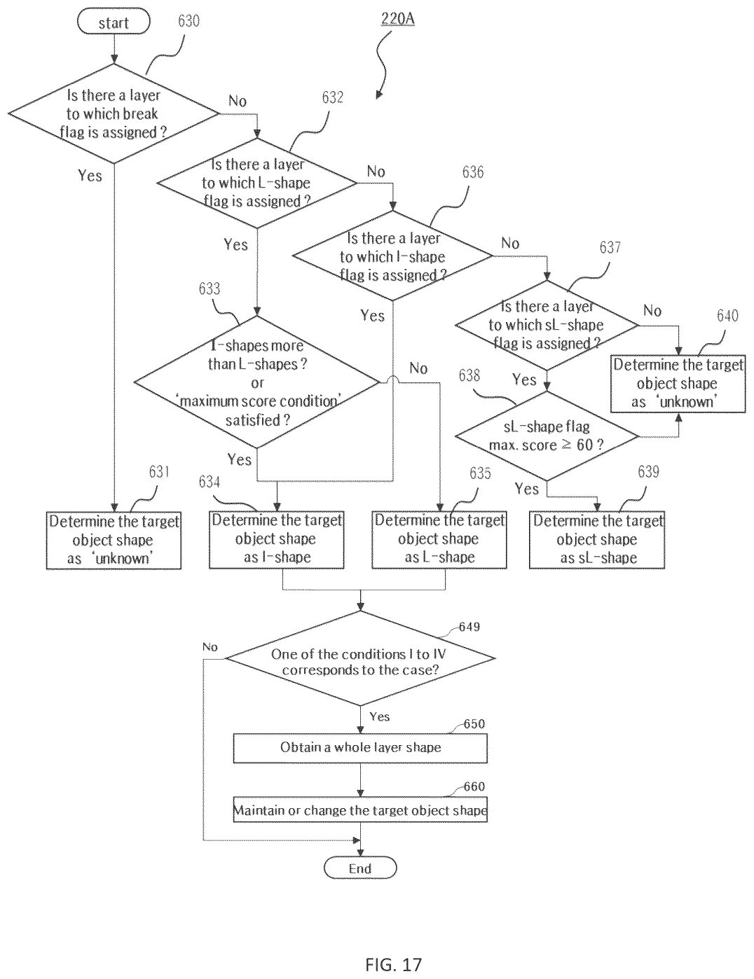

FIG. 17 is a flowchart of an embodiment 220A of step 220 shown in FIG. 2.

Performing step 220, i.e. the determination of the shape of a target object may be made with the process that the shape is determined basically according to the priority order of the shapes, in which the L-shape comes first, the I-shape next, and the sL-shape last, and then modified according to the first scores or the second score.

Described in brief, though detailed below, the determination according to the priority order may comprise determining first whether there is a layer of the L-shape flag among the layers for the detected object, and if not, determining whether there is a layer of the I-shape flag, and if not L-shape nor I-shape, determining whether there is a layer of the sL-shape flag.

In order to perform the embodiment 220A shown in FIG. 17, as shown in FIG. 3, the target shape determination unit 144 may include first to fourth flag inspection units 192, 194, 196 and 197, and a final shape output unit 198.

The first flag inspection unit 192 checks whether there is a layer to which the break flag has been assigned, among the first to M^{th} layers, and outputs the result of the checking to the final shape output unit 198 (step 630). Upon determining that there is a layer to which the break flag has been assigned, among the first to M^{th} layers, based on the result of the checking by the first flag inspection unit 192, the final shape output unit 198 determines that the shape of the target object is ‘unknown’ (step 632).

The second flag inspection unit 194, in response to the result from the first inspection unit 192 that there is no break-flag layer, checks whether there is a layer to which the L-shape flag is assigned (step 632), and outputs the check result to the third flag inspection unit 196 (No in step 632) or performs a subsequent check (step 633). In case where there is at least one L-shape flag layer (step 632), whether the number of I-shape flag layers is larger than that of L-shape flag layers (first condition) or the ‘maximum score condition’ (second condition) detailed below is fulfilled is subsequently checked (step 633), and the result is output to the final shape output unit 198. The final shape output unit 198 determine I-shape as the target object shape if it is determined according to the received result that at least one of the first and second conditions is fulfilled (step 634), otherwise L-shape (step 635).

In the above description, the ‘maximum score condition’ may be defined that the maximum of the first scores of the L-shape flag layers is below a first predetermined score and the maximum of the second scores of the I-shape flag layers is equal to or over a second predetermined score. If there is a L-shape flag layer, then the shape of the target object is determined by the L-shape flag according to the priority order rule, however, nonetheless, if there is a I-shape flag which can represent better the heading, in other words, the maximum score condition is fulfilled, then more precise heading information is obtained by determining the shape of the target object to be the I-shape flag.

Upon recognizing that there is no layer to which the L-shaped flag has been assigned based on the result of the checking by the second flag inspection unit 194, the third flag inspection unit 196 checks whether there is a layer to which the I-shaped flag has been assigned (step 636) and outputs the result of the checking to the final shape output unit 198. Upon recognizing that there is no layer to which any one of the break flag and the L-shaped flag has been assigned but there is a layer to which the I-shaped flag has been assigned, among the first to M^{th} layers, based on the results of the checking by the first to third flag inspection units 192, 194 and 196, the final shape output unit 198 determines that the target object has an “I” shape (step 634). The third flag inspection unit 196, on the other hand, if it is determined that there is no I-shape flag layer in step 636 (No in step 636), may output the result to the fourth flag inspection unit 197.

The fourth flag inspection unit 197, in response to the result from the third flag inspection unit 196, checks whether there is a layer to which a sL-shape flag is assigned (step 637), and outputs the check result to the final shape output unit 198. If there is no sL-shape flag layer according to the result checked by the fourth flag inspection unit 197, then the final shape output unit 198 determines the shape of the target object as ‘unknown’ (step 640). On the other hand, if it is determined that there is a sL-shape flag layer (Yes in step 637), then fourth flag inspection unit 197 subsequently checks whether the maximum score of the second scores of the sL-shape flag layers is equal to or over a third predetermined score (step 638), and outputs the result to the final shape output unit 198. The final shape output unit 198 may determine the shape of the target object as sL-shape if the maximum score is equal to or over the third predetermined score (step 639), and otherwise ‘unknown’ (step 640).

As described above, when the final shape output unit 198 determines the shape of the target object, the break flag, the L-shaped flag, the I-shaped flag, and the sL-shaped flag are checked in that order.

On the other hand, upon recognizing that there is no layer to which any one of the break flag, the L-shaped flag, and the I-shaped flag has been assigned, among the first to M^{th} layers, based on the results of the checking by the first to fourth flag inspection units 192, 194, 196 and 197, the final shape output unit 198 determines that the shape of the target object is ‘unknown.’

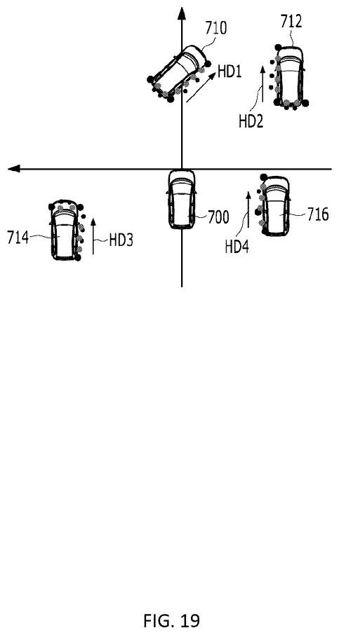

FIG. 19 shows various types of target vehicles 710 to 716 on the basis of the host vehicle 700.

Referring to FIG. 19, the target vehicle 716, only the side surface of which is scanned from the host vehicle 700, has an I-shaped contour, and the target vehicles 710, 712 and 714, the side surfaces and the bumpers of which are scanned from the host vehicle 700, have L-shaped (including sL-shaped) contours. A moving object in a downtown area or an expressway mainly has an L-shaped contour or an I-shaped contour. Therefore, it is possible to temporarily determine in step 318 whether an object has an I-shaped contour or an L-shaped contour based on the size of the shape box SB having the form of a contour.

The contour of a target vehicle, which is a target object, may be determined by the object-tracking device 100 and the object shape analysis method 200 using a LiDAR sensor according to the embodiments described above. For example, referring to FIG. 19, the target vehicles 710, 712 and 714 may be determined to have L-shaped contours, and the target vehicle 716 may be determined to have an I-shaped contour. In this case, the object-tracking device 100 according to the embodiment may recognize the heading directions of the target vehicles 710 to 716 using the determined contours of the target vehicles. For example, when the target vehicles 710 to 716 have L-shaped and I-shaped contours, the heading directions of the target vehicles 710 to 716 may be directions (e.g. HD1, HD2, HD3 and HD4 shown in FIG. 19) parallel to the longer one of the first line segment L1 and the second line segment L2.

To determine the heading of a detected object, it may be necessary to select a layer or flag (hereinafter, referred to as ‘heading layer’ or ‘heading flag’) for using for the determination among the corresponding layers.

In the present embodiment, the L-shape flag, of which the first score is greatest among all the L-shape flags, may be determined to be the heading flag if L-shape flag is determined as the shape of the target object, the I-shape flag, of which the second score is greatest among all the I-shape flags, may be determined to be the heading flag if I-shape flag is determined as the shape of the target object, and the sL-shape flag, of which the first score is greatest among all the sL-shape flags, may be determined to be the heading flag if sL-shape flag is determined as the shape of the target object. That is, the heading of the corresponding object may be determined according to the maximum score rule among the same shape flags as the one determined as the shape of the corresponding object. And the determination of the heading layer or flag may be performed by the final shape output unit 198.

On the other hand, in case where the shape of the target object is determined as I-shape or L-shape through the above described process, but the confidence score is low, steps 649, 650, and 660 of FIG. 17 may be added to obtain a shape or heading information of a higher confidence score.

At first, in step 649, it is determined which of the below conditions I to IV corresponds to the case.

Condition I

This condition is whether the L-shape flag is temporarily determined according to the priority order rule due to the L-shape flag being assigned to at least one among the layers (step 632), but the shape of the corresponding target object is finally determined to be the I-shape flag in step 634 because the number of I-shape flag layers is greater than that of L-shape flag layers or the ‘maximum score condition’ is satisfied (step 633), i.e., whether the case is ‘Yes’ in step 632 and also ‘Yes’ in step 633.

Condition I is for such case as the I-shape is assigned to some layers due to failure of obtaining LiDAR points corresponding to the bumper of a target object because of occlusion.

Condition II

This condition is whether the first score of the heading layer or the heading flag is equal to or below a fourth predetermined score in case where the L-shape is determined as the shape of a target object.

This condition is for determining the shape of a target object by additionally analyzing a whole layer shape which is a shape determined by use of LiDAR points on a whole layer and is detailed below, so as to keep inaccurate heading information from being determined for the object whose shape is determined to be the L-shape flag despite the low first score of the heading flag.

Condition III

This condition is whether a difference of distances of the shape box and the cluster box from the host vehicle is equal to or over a predetermined value.

This condition is for such case as the L-shape flag is determined for one layer, but does not match the cluster box with overall shape taken into consideration because noise (e.g., noise points by exhaust gas from the target object) is included.

Condition IV

This condition is whether only one layer among the first to M^{th} layers is assigned by the L-shape flag and thus the L-shape flag is finally determined as the shape of the object.

If the L-shape flag is assigned to only one layer and thus the shape of the corresponding object is determined to be the L-shape, then the flag is determined as the heading flag, however, it may not be appropriate to determine accurately the heading and this condition is for such case. In this case, the distribution of the LiDAR points on the corresponding layer may not be sparse and thus the first score may be high.

Step 649 may be performed by the final shape output unit 198, and if any one of the conditions I to IV is satisfied, then a determination of a whole layer shape is performed (step 650).

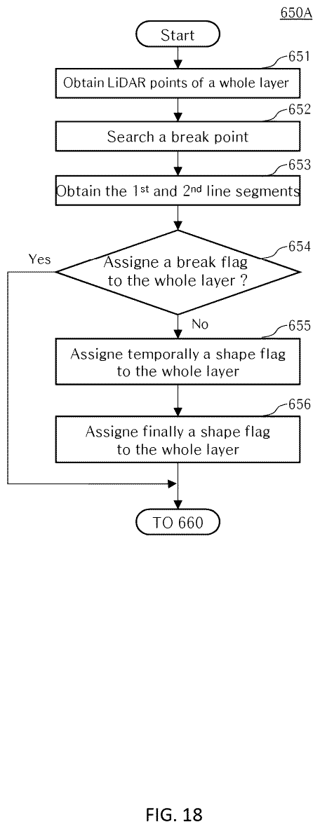

FIG. 18 is an example of a process 650A of determining a whole layer shape (step 650).

First, ‘whole layer’ data is formed by projecting the whole LiDAR points of the target object onto a layer (step 651). In the present embodiment, the whole layer is defined as a layer onto which the whole LiDAR points of the target object are projected.

The whole layer may be selected from the first to M^{th} layers, or may be defined as a layer which is placed on a plane different from the first to M^{th} layers. For example, the whole layer is defined as a plane which is placed at the vertical center of the whole cloud points of the corresponding object.

LiDAR points of the whole layer may be obtained from the points of the first to M^{th} layers, but not limited thereto.

For example, the LiDAR points of the whole layer may be obtained by projecting the whole cloud points obtained by the LiDAR sensor 110 onto a layer, and data-processed through the preprocessing unit 120 and the clustering unit 130 (proceeded to ‘A’ path in FIG. 3). In case where the whole cloud points obtained from the LiDAR sensor 110 are projected onto a layer to obtain the whole layer data without using the data of the pre-existing layers, it is advantageous that error which may be included in outer points of the pre-existing layers may be excluded especially because outer points are extracted regardless of the data of the pre-existing layers.

On the other hand, in case of the whole layer data being obtained from the points of the first to M^{th} layers (proceeded to ‘B’ path in FIG. 3), it is advantageous that cost and time for data processing are reduced because data processing through the preprocessing unit 120 and the clustering unit 130 does not have to be done.

After the whole layer obtained, likewise for the first to M^{th} layers, the process for analyzing a shape for the LiDAR points is performed. That is, a break point is searched for (step 652), first and second line segments obtained (step 653), whether break flag is assigned to the whole layer or not determined (step 654), a shape flag temporarily assigned (step 655), and the shape flag of the whole layer finally determined (step 656).

The steps 652 to 656 are substantially the same as the steps 312, 314, 316, 318, and 320, respectively, of FIG. 4, which are the process for determining shape flags for the first to M^{th} layers, and thus detailed description thereof is omitted.

After the shape flag determined for the whole layer, step 660 is performed which is detailed below.

At first, if the condition I is satisfied (true) and the L-shape or sL-shape flag is determined as the shape of the whole layer, the shape of the corresponding object is determined by the shape flag of the whole layer. In other words, in case where though temporarily determined to be the L-shape flag according to the priority order rule due to at least one layer being assigned by the L-shape flag (step 632), the shape of the corresponding object is finally determined to be the I-shape flag (step 634) because the I-shape flag layers are more than the L-shape flag layers or the ‘maximum score condition’ is satisfied (step 633), the shape of the object is changed to the L-shape or sL-shape flag according to the shape of the whole layer. Here, though used for the determination of the shape, the whole layer may not be used for a determination of the heading of the object.

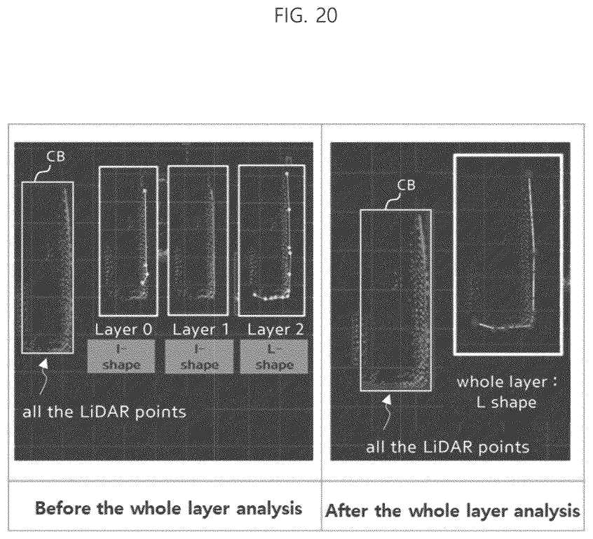

FIG. 20 represents an actual test result for this case, which shows an example of the determination of a shape flag.

FIG. 20 is for the case where the I-shape flag is determined for two (layers 0 and 1) of the layers of LiDAR points for a target object and the L-shape flag is determined for one layer (layer 2). In this case, before applying the additional whole layer analysis, the shape of the target object is determined firstly to be the L-shape flag according to the priority order rule, and finally to be the I-shape through step 633 of FIG. 17 because the I-flags are more than the L-shape flag. However, the condition I is true, and thus a whole layer shape is additionally analyzed and determined to be the L-shape flag, so the final shape of the corresponding object is changed to be the L-shape.

As shown in FIG. 20, it is understood that the L-shape is a more proper shape for the object if the whole LiDAR points of the corresponding object are considered, and the shape of the object can be correctly determined to be the L-shape through the additional analysis for the whole layer shape.

Next, if any one of the conditions I to IV is true, and the whole layer shape is determined to be the L-shape for sL-shape flag, then the shape of the corresponding object is changed to be the shape flag of the whole layer and the heading flag is also changed to be the shape flag of the whole layer. That is, in case where any one of the conditions I to IV is true, because the shape and the heading information of the corresponding object obtained from the analysis of the shapes of the first to M^{th} layers are not appropriate, they are changed by the shape flag of the whole layer.

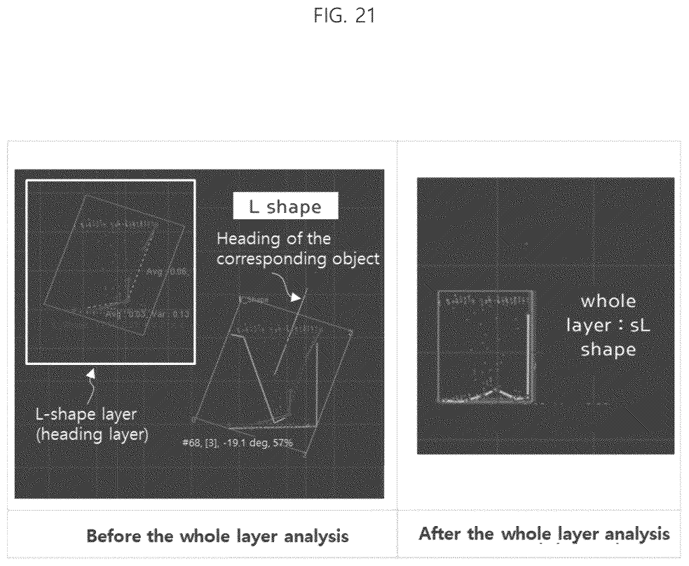

FIG. 21 represents an actual test result for this case, which shows an example of the determination of a shape flag.

In FIG. 21, the left picture shows that the shape flag (i.e., heading flag) of the heading layer selected among the first to M^{th} layers is the L-shape, and the heading information is being slanted clockwise with an angle of 19.1°. And the right picture shows, as the result of additionally applying the whole layer analysis, that the shape flag of the whole layer is the sL-shape and the heading information is approximately 0°.

FIG. 21 shows that inaccurate shape and heading information may be determined for the corresponding object if the additional whole layer analysis is not applied, and they can be corrected through the additional whole layer analysis.

Next, in case where the above condition III is true, if the whole layer shape analysis results in neither the L-shape nor sL-shape, the shape flag determined for the corresponding object is deleted and changed to ‘unknown.’ And also, the heading flag determined for the object is deleted.

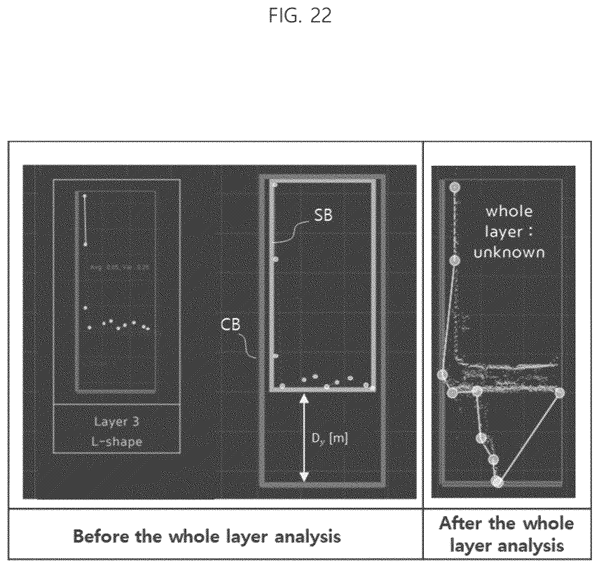

FIG. 22 represents an actual test result for this case, which shows an example of the determination of a shape flag.

As shown in FIG. 22, there comes the L-shape in ‘Layer 3,’ but the distance between the shape box SB and the cluster box CB, i.e., the difference D_{y} of distances from the host vehicle is equal to or over a predetermined value. Though no included in ‘Layer 3,’ error points due to the exhaust gas from the target vehicle may be included in other layers, and this may cause a large discrepancy between the shape box SB and the cluster box CB, at least a difference of distances along the y axis as shown in FIG. 22.

In this case, because error points are all considered in the whole layer and its shape analysis is performed, the outer points and the segments appear as shown at the right picture of FIG. 22, and the object shape is changed to be ‘unknown.’

Next, in case where any one of the conditions II and IV is true, if the whole layer analysis results in neither the L-shape nor sL-shape, the shape flag previously determined for the corresponding object is maintained valid, and the heading information by the heading flag is deemed to be inappropriate and deleted.

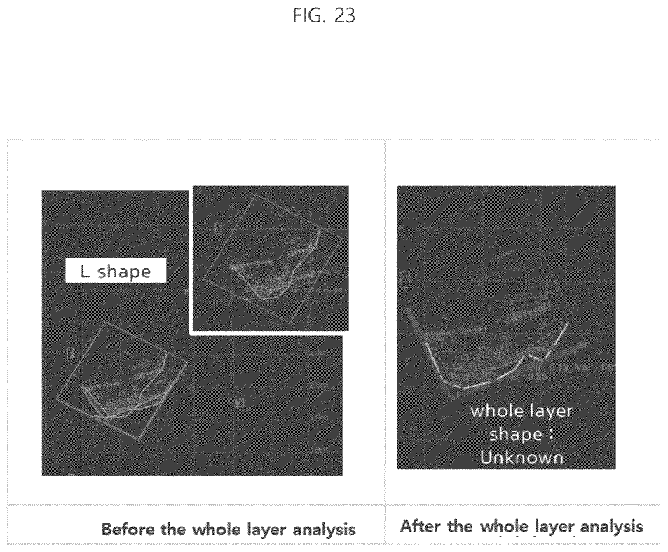

FIG. 23 represents an actual test result for this case, which shows an example of the determination of a shape flag.

As shown in FIG. 23, in case where the L-shape is determined before the whole layer shape analysis, the previously determined shape flag is maintained valid but the heading information by the heading flag is deemed to be inappropriate and deleted if the whole layer shape analysis performed due to any one of the conditions II and IV being true results in ‘unknown.’

What is claimed is:

1. A method for analyzing a shape of an object by use of a LiDAR sensor, the method comprising:
obtaining first to M^{th} (M is an integer of 2 or greater) layers of LiDAR points spaced apart in a vertical direction with respect to an object by the LiDAR sensor;
obtaining LiDAR points of a whole layer by projecting whole LiDAR points for the object obtained by the LiDAR sensor onto the whole layer or projecting LiDAR points of the first to M^{th} layers onto the whole layer; and
determining shape flags for the first to M^{th} layers and the whole layer, respectively, by use of at least a part of corresponding LiDAR points of each layer according to a plurality of predetermined shape types, and determining a shape flag of the object.

2. The method of claim 1, wherein the determining of the shape flag of the object comprises steps of:
(a) determining the shape flags for the respective first to M^{th} layers;
(b) determining the shape flag of the object firstly by use of the shape flags of the first to M^{th} layers; and
(c) determining the shape flag for the whole layer and accordingly changing or maintaining the firstly determined shape flag of the object.

3. The method of claim 2, wherein the step (c) is performed according to a predetermined reliability condition for the firstly determined shape flag of the object.

4. The method of claim 3, wherein the predetermined reliability condition includes one or more of:
condition I representing whether a L-shape flag is temporarily determined as the shape flag of the object according to a priority order rule due to a L-shape flag being assigned to at least one among the first to M^{th} layers and I-shape flag layers are more than L-shape flag layers or a maximum score among L-shape flag scores is below a predetermined first score and a maximum score of I-shape flag scores is equal to or over a predetermined second score;
condition II representing whether when the firstly determined shape flag of the object is a L-shape, a heading flag score for the object is equal to or below a predetermined score;
condition III representing whether, with respect to the firstly determined shape flag of the object, a difference of distances from a host vehicle to a shape box and a cluster box for the object in its heading layer is equal to or over a predetermined value; and
condition IV representing whether only one of the first to M^{th} layers is determined as the L-shape flag and thus the firstly determined shape flag of the object becomes a L-shape.

5. The method of claim 4, wherein the step (c) comprises changing the shape of the object according to the shape flag of the whole layer when the condition I is true and the L-shape or an sL-shape flag is determined as the shape flag of the whole layer.

6. The method of claim 5, wherein heading information on the object is determined according to the firstly determined shape flag of the object.

7. The method of claim 4, wherein the step (c) comprises changing the shape of the object according to the shape flag of the whole layer when any one of the conditions II to IV is true and the L-shape or an sL-shape flag is determined as the shape flag of the whole layer.

8. The method of claim 7, wherein heading information on the object is determined according to the shape flag of the whole layer.

9. The method of claim 4, wherein the step (c) comprises changing the shape of the object to be ‘unknown’ when the condition III is true and neither the L-shape nor an sL-shape flag is determined as the shape flag of the whole layer.

10. The method of claim 9, wherein a heading flag determined for heading information on the object is deleted.

11. The method of claim 4, wherein the firstly determined shape flag of the object is maintained when any one of the conditions II to IV is true and the shape flag of the whole layer is neither the L-shape nor an sL-shape flag.

12. The method of claim 11, wherein a heading flag determined for heading information on the object is deleted.

13. The method of claim 2, wherein the firstly determining of the shape flag of the object comprises:
calculating each of confidence scores for each of the shape flags of the first to M^{th} layers by use of the at least part of the corresponding LiDAR points; and
determining the shape flag of the object by use of the shape flags and the confidence scores for the first to M^{th} layers.

14. A device for tracking an object by use of a LiDAR sensor, the device comprising:
the LiDAR sensor configured to obtain a point cloud including LiDAR points for a target object;
a clustering unit configured to group the LiDAR points of the point cloud; and
a shape analysis unit configured to analyze a shape of the target object from the grouped LiDAR points of the point cloud,
wherein the shape analysis unit comprises:
a layer shape determination unit configured to determine shape flags for first to M^{th} layers and a whole layer, respectively, by use of at least a part of corresponding LiDAR points of each layer according to a plurality of predetermined shape types, the first to M^{th} (M is an integer of 2 or greater) layers spaced apart in a vertical direction with respect to the target object and LiDAR points of the whole layer obtained by projecting whole LiDAR points for the target object or LiDAR points of the first to M^{th} layers onto the whole layer in the vertical direction; and
a target shape determination unit configured to determine a shape flag of the object by use of the shape flags of the first to M^{th} layers and the whole layer.

15. The device of claim 14, wherein the determination of the shape flag of the object is performed by steps of:
(a) determining the shape flags for the respective first to M^{th} layers;
(b) determining the shape flag of the object firstly by use of the shape flags of the first to M^{th} layers; and
(c) determining the shape flag for the whole layer and accordingly changing or maintaining the firstly determined shape flag of the target object.

16. The device of claim 15, wherein the step (c) is performed according to a predetermined reliability condition for the firstly determined shape flag of the object.

17. The device of claim 16, wherein the predetermined reliability condition includes one or more of:
condition I representing whether a L-shape flag is temporarily determined as the shape flag of the object according to a priority order rule due to a L-shape flag being assigned to at least one among the first to M^{th} layers and I-shape flag layers are more than L-shape flag layers or a maximum score among L-shape flag scores is below a predetermined first score and a maximum score of I-shape flag scores is equal to or over a predetermined second score;
condition II representing whether when the firstly determined shape flag of the object is a L-shape, a heading flag score for the object is equal to or below a predetermined score;
condition III representing whether, with respect to the firstly determined shape flag of the object, a difference of distances from a host vehicle to a shape box and a cluster box for the object in its heading layer is equal to or over a predetermined value; and
condition IV representing whether only one of the first to M^{th} layers is determined as a L-shape flag and thus the firstly determined shape flag of the object becomes a L-shape.

18. A vehicle comprising: a device for tracking an object by use of a LiDAR sensor, the device comprising:
the LiDAR sensor configured to obtain a point cloud including LiDAR points for a target object;
a clustering unit configured to group the LiDAR points of the point cloud; and
a shape analysis unit configured to analyze a shape of the target object from the grouped LiDAR points of the point cloud,
wherein the shape analysis unit comprises:
a layer shape determination unit configured to determine shape flags for first to M^{th} layers and a whole layer, respectively, by use of at least a part of corresponding LiDAR points of each layer according to a plurality of predetermined shape types, the first to M^{th} (M is an integer of 2 or greater) layers spaced apart in a vertical direction with respect to the target object and LiDAR points of the whole layer obtained by projecting whole LiDAR points for the target object or LiDAR points of the first to M^{th} layers onto the whole layer in the vertical direction; and
a target shape determination unit configured to determine a shape flag of the object by use of the shape flags of the first to M^{th} layers and the whole layer.

19. The vehicle of claim 18, wherein the layer shape determination determines the shape flags for the first to Mth layers and the whole layer by steps of:
(a) determining the shape flags for the respective first to M^{th} layers;
(b) determining the shape flag of the object firstly by use of the shape flags of the first to M^{th} layers; and
(c) determining the shape flag for the whole layer and accordingly changing or maintaining the firstly determined shape flag of the object.

20. The vehicle of claim 19, wherein the step (c) is performed according to a predetermined reliability condition for the firstly determined shape flag of the object.
